(19) United States
(12) Patent Application Publication
(10) Pub. No.: US 2015/0079492 A1
(43) Pub. Date: Mar. 19, 2015

(54) DEVICE FOR SUPPLYING A FUEL CELL WITH FUEL

(71) Applicant: Hans-Joerg Heidrich, Ulm (DE)

(72) Inventor: Hans-Joerg Heidrich, Ulm (DE)

(73) Assignee: Daimler AG, Stuttgart (DE)

(21) Appl. No.: 14/391,019

(22) PCT Filed: Mar. 30, 2013
(86) PCT No.: PCT/EP2013/000962

§ 371 Date: Oct. 7, 2014

(30) Foreign Application Priority Data
Apr. 12, 2012 (DE) 10 2012 007 376 3

(51) Int. Cl. H01M 8/04

(52) U.S. Cl. CPC H01M 8/04089
USPC 429/444

(57) ABSTRACT

A device for supplying fuel to a fuel cell (3) via a metering valve (8). The metering valve (8) is a proportional valve. A pulsation device (14) is situated downstream from the metering valve (8) in the flow direction, by means of which the pressure and/or volume flow of the metered fuel flow may be varied.

The invention relates to a device for supplying fuel to a fuel cell of the type defined in greater detail in the preamble of claim 1.

Fuel cell systems and devices for supplying fuel to fuel cells in such fuel cell systems are known from the general prior art. For PEM fuel cells, for example, hydrogen or a gas containing hydrogen is typically used as fuel. The metering of this hydrogen must be carried out as a function of the required power to be delivered by the fuel cell. In laboratory setups, a proportional valve is generally used for this purpose in order to continuously change the cross section in such a way that the desired quantity of fuel is metered. In series production applications, a design which is composed of one or more valves which is/are controlled in a clocked manner and typically easier and more cost-effective to actuate is used very often instead of the proportional valve. The disadvantage of the design is that the clocked valves are very loud, so that a high noise level results in the otherwise very quiet fuel cell system on account of the clocked metering valves. This is extremely undesirable, in particular in mobile applications such as fuel cell systems which are used in vehicles for providing electrical power, in particular for providing electrical drive power.

The object of the present invention is to provide a device for supplying fuel to a fuel cell via at least one metering valve, which avoids this disadvantage and ensures the best possible functionality of the fuel cell as a result of the device for supplying fuel to the fuel cell.

According to the invention, this object is achieved by the features in the characterizing part of claim 1. Advantageous embodiments and refinements of the fuel cell system according to the invention result from the remaining dependent claims. In addition, a fuel cell system having this type of device according to the invention is set forth in claim 10.

In the device according to the invention for supplying fuel to a fuel cell, it is provided that the at least one metering valve is designed as a proportional valve. As a result, in particular for small volume flows of the metered fuel, much lower noise levels are produced than would be the case for a comparable volume flow through one or more pulse-controlled metering valves. The device according to the invention for fuel metering for a fuel cell additionally combines the at least one metering valve with a pulsation device downstream from the metering valve in the flow direction, by means of which the pressure and/or volume flow of the metered fuel flow may be varied. This particularly advantageous integration of a pulsation device independently of the at least one metering valve allows use of suitable pulsation devices in order to ensure the desired pulsation at the desired volume flows of the metered fuel, in particular for small and average volume flows of the metered fuel, in the most efficient manner possible and with minimal noise levels. Use may thus be made of the advantages of the pulsation without producing increased noise levels, as is the case with clocked metering valves. The advantage of pulsation in particular is that due to the pulsation, an increased pressure drop results in the so-called anode flow field of the fuel cell, over which the gases in the anode chamber are distributed. Due to the pressure drop which is at least intermittently increased, the discharge of liquid water from the anode flow field of the fuel cell is improved. Higher power of the fuel cell, less degradation, and thus an improved service life of the fuel cell, may thus be achieved. The advantages of pulsation may be utilized in the device according to the invention without having to accept the disadvantages of a high noise level, as is the case with clocked metering valves.

The pulsation device itself may have any given design in principle. It may be actively controlled, for example, or may be implemented in particular as a passively functioning mechanical design.

Accordingly, one advantageous refinement of the invention provides that a movable element automatically moves in a pulsing manner due to a variable force which is produced by the flow, and a counterforce. This particularly advantageous embodiment of the invention allows the pulsing fuel flow to be generated without having to actively intervene in the fuel flow by control or regulation. The pulsing fuel flow may thus be achieved entirely independently of the metering via a movable element which, due to the variable force which is produced by the flow and a counterforce which act in opposition to one another, and a fluctuating force or pressure difference, moves in a pulsing manner, once in the direction the one force and once in the direction of the other force.

According to one particularly beneficial and advantageous refinement of the device, it is provided that the movable element is designed as a flap which is fastened in a rotationally movable manner to a front end, in the direction of the fuel flow, outside the center of the fuel flow. Such a flap which is fastened off-center will always experience a resultant force in one direction due to the flow on and around it. The flap is thus initially deflected in the one direction until a force equilibrium is established. The flap is moved slightly beyond this force equilibrium by inertia, and then experiences a resultant force in the other direction, and thus moves back once again. According to one particularly beneficial and advantageous refinement, in addition the weight of the flap and/or the force of a spring may be provided as a counterforce in order to push the flap into the flow.

In one alternative embodiment of the device according to the invention. it may be provided that the pulsation device has an outlet nozzle, and a deflection element whose distance from the outlet nozzle is freely changeable by moving at least between a position which closes the outlet nozzle and a position at a distance from the outlet nozzle, the outlet nozzle having an outlet opening and an extension which corresponds to the deflection element, so that a gap through which more or less flow passes is formed between the deflection element and the extension of the outlet nozzle as a function of the automatically changing position of the deflection element.

This embodiment of the pulsation device of the device according to the invention makes use of the so-called hydrodynamic paradox in order to achieve a pulsing flow. The deflection element is situated in front of the outlet nozzle in such a way that it deflects the flow, as a result of which the flow passes through a narrow gap between the deflection element and the outlet nozzle. The narrower this gap, the higher the flow velocity. This results in lower pressure in the area between the gap and the extension of the outlet nozzle than in the surroundings. The deflection element is thus moved in the direction of the outlet opening in the outlet nozzle, which makes the gap even smaller and further intensifies the effect. Eventually, the deflection element closes the outlet nozzle. The flow then abruptly ceases, and ambient pressure becomes established everywhere, thus lifting the deflection element from the extension of the outlet nozzle. Fuel then flows again through the flow gap which is once again formed, and the described process begins anew. The process thus generates a pulsing flow of the fuel flow which has a higher frequency with increasing flow velocity of the fuel.

According to one advantageous refinement of the device according to the invention, it may also be provided that a fixing device for fixing the movable element is provided in the pulsation device. The movable element may be fixed by means of such a fixing device, which in particular may be equipped to be actively switchable. It is thus possible to switch off the pulsation in the above-described manner. This may be meaningful, for example, at higher loads or higher volume flows.

In one very advantageous embodiment thereof, it is accordingly provided that the movable element is fixed in a position which largely enables the flow. The fixing thus takes place in such a way that the movable element is preferably fixed in its end position which opens up the maximum flow cross section, so that a change may be made from a pulsing gas flow to a continuous gas flow.

In one particularly advantageous refinement of the device according to the invention, it is additionally or alternatively provided that a by-pass line having a valve unit is situated around the pulsation device. Such a by-pass around the pulsation device, which is designed to be switchable via a valve unit, provides an alternative option for by-passing, and thus switching off, the pulsation device as needed.

Such a need is present in particular under high metered fuel volume flows, as previously stated. In these situations, for a mechanically designed pulsation device it is ideal to switch off the movable element, or, as an addition or alternative for pulsation devices having a different design, to by-pass the pulsation device. Such by-passing of the pulsation device or switching it off under high volume flows then ensures that in high load ranges, the comparatively large pressure pulses on the fuel cell and in particular on the membranes in the embodiment as a PEM fuel cell cease or at least significantly decrease. The very high stress on the membranes, in particular at full load, is thus reduced, and the service life of the fuel cell is extended. In addition, at full load a pressure loss is typically present over the anode flow field of the fuel cell which is so high that the discharge of water is possible without difficulty, even without pulsation of the metered-in fuel flow.

Instead of controlling as a function of the volume flow, it is of course also possible to control as a function of the power of the fuel cell, since the latter is directly related to the volume flow of metered-in fuel.

Furthermore, the invention describes a fuel cell system having at least one fuel cell and a device for supplying fuel to the fuel cell, the device being designed as a device according to the invention in one of the embodiment variants described above.

Further advantageous embodiments of the device according to the invention and of the fuel cell system according to the invention result from the remaining dependent subclaims, and are apparent based on the exemplary embodiments, which are described in greater detail below with reference to the figures, which show the following.

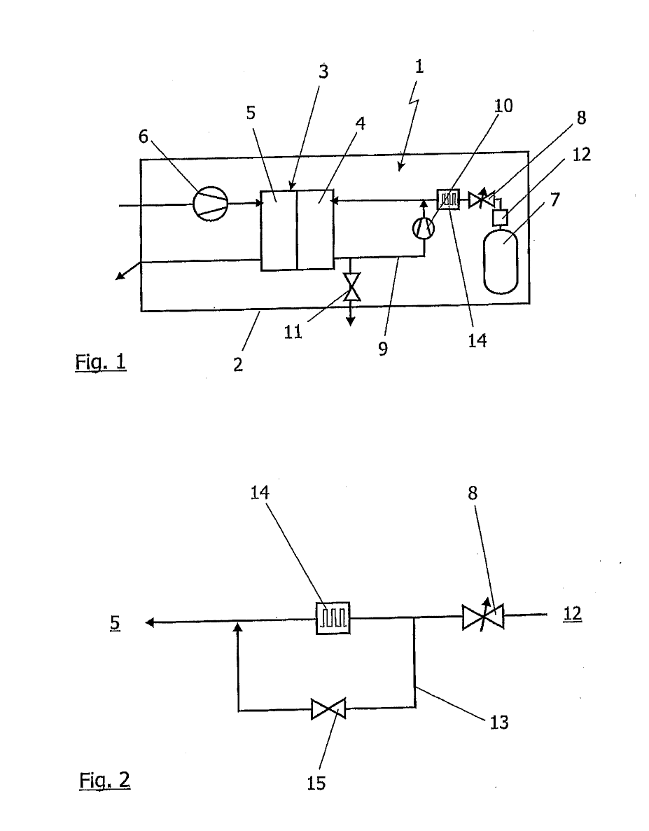

FIG. 1 shows a detail of a fuel cell system according to the invention;

FIG. 2 shows one possible embodiment of a device according to the invention;

FIG. 3 shows one possible embodiment of a pulsation device of a device according to the invention;

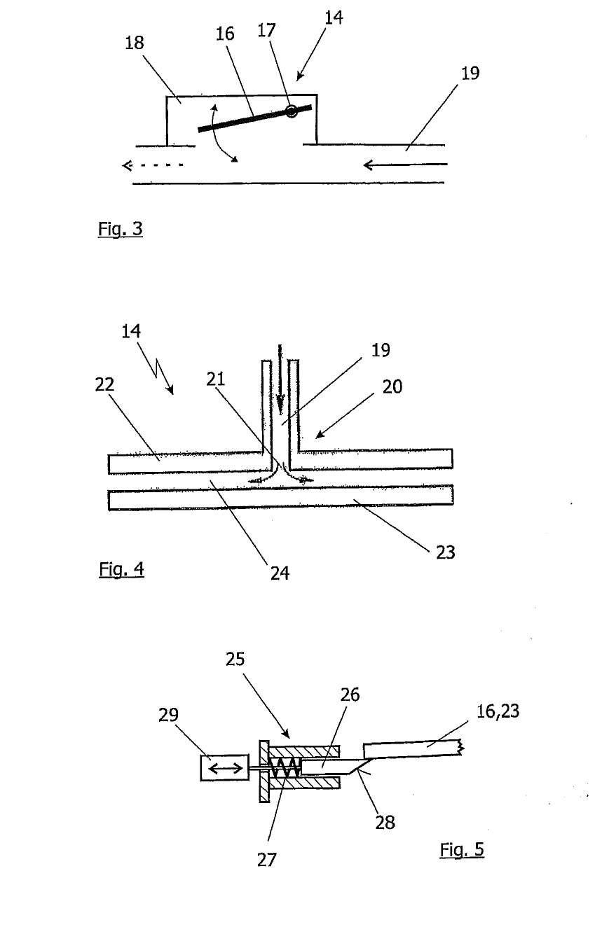

FIG. 4 shows one possible alternative embodiment of a pulsation device of a device according to the invention; and

FIG. 5 shows one possible embodiment of a fixing device.

A fuel cell system 1 which is intended to be provided in a vehicle 2, indicated by way of example, is illustrated In FIG. 1. The core of the fuel cell system is formed by a fuel cell 3 designed as a PEM fuel cell stack. The fuel cell 3 includes an anode chamber 4 and a cathode chamber 5. The cathode chamber 5 is to be supplied with air as the oxygen supplier in a manner known per se via an indicated air conveying device 6. The exhaust air from the cathode chamber 5 then passes to the environment. This description is to be understood as highly simplified and strictly as an example. Of course, a module for exchanging heat and/or moisture could also be situated between the supply air and the exhaust air, or a turbine could be provided in the area of the exhaust air in order to recover energy from the exhaust air.

Hydrogen from a pressurized gas store 7 is supplied as fuel to the anode chamber 4 of the fuel cell 3. The hydrogen passes through a pressure reducer 12 and a metering valve 8, designed as a proportional valve, and into the anode chamber 4 of the fuel cell 3. Unconsumed hydrogen together with inert gas, in particular nitrogen, which has diffused through the membranes of the fuel cell 3 from the cathode chamber 5 into the anode chamber 4, as well as a portion of the product water of the fuel cell 3, passes through a recirculation line 9 and back to the inlet of the anode chamber 4, which is supplied with the recirculated exhaust gas together with fresh hydrogen. To compensate for the pressure losses in the anode chamber 4 and in the recirculation line 9, a recirculation conveying device 10 is provided in a manner known per se. This recirculation conveying device 10 may be designed, for example, as a gas jet pump and/or as a recirculation fan, i.e., a flow compressor. Over time, water and inert gases accumulate in such an anode recirculation system, and, for example, must be discharged occasionally or as a function of the quantity and/or concentration of materials which arise. An exhaust valve 11, illustrated in FIG. 1, is provided for this purpose. There is no further discussion of the exhaust valve below since it has no further relevance for the present invention.

Hydrogen as fuel passes from the above-mentioned pressurized gas store 7, through the pressure reducer 12, and to the metering valve 8, which is designed as a proportional valve. The required volume flow of fuel may be continuously metered very precisely in this way. The proportional valve 8 as a metering valve has the advantage that, unlike a clock valve, it does not produce high noise levels during metering of the fuel. However, the proportional valve produces a continuous volume flow which does not pulse. In particular for low loads and associated low volume flows of fuel, this may be disadvantageous, since as a result, the pressure drop is lower in the area of the anode chamber 4, and it is more difficult to discharge product water that is formed. For this reason, the design provides a pulsation device 14 downstream from the metering valve 8 in the flow direction, via which pulsation of the metered fuel flow is generated, at least in some operating states of the fuel cell system 1. The pulsation device 14 may have any desired design. It may be designed, for example, as an actively controlled pulsation device 14 or as a pulsation device 14 which is automatically passively driven by the volume flow of the fuel, in particular in the manner to be described in greater detail below. The pulsation device 14 is advantageous in particular for a low volume flow of the fuel, since more water is discharged from the area of the anode chamber 4, and here in particular, the anode flow field, due to larger pressure differences. It is thus possible to achieve higher power, reduce the degradation, and extend the service life of the fuel cell 3.

In contrast, for very high volume flows the pulsation is rather critical, since it ensures very high pressure pulses which for a very high volume flow may become so great that the membranes between the anode chamber 4 and the cathode chamber 5 of the fuel cell 3 are severely damaged. In this case, the pulsation has a rather adverse effect on the service life. In addition, the pressure losses, even for a continuously flowing high volume flow of fuel, are so great that pulsation affords no advantages with regard to the water discharge. For these situations, it may then be provided that the pulsation device 14, which is apparent in the detail illustrated in FIG. 2, has a by-pass line 13 with a by-pass valve 15. For a volume flow which exceeds a certain predefined magnitude, the by-pass valve 15 may then be opened. The fuel no longer flows through the pulsation device 14, but, rather, through the by-pass line 13. The pulsation device 14 is thus completely or at least largely disconnected from the volume flow of the fuel, resulting in a continuous fuel flow or a fuel flow with minimal pulsations.

The illustration in FIG. 3 shows a first possible exemplary embodiment of such a pulsation device 14. The pulsation device 14 in the embodiment according to FIG. 3 is composed essentially of a flap 16 which forms the movable element. Ideally, the flap 16 is fastened on one side, specifically, at the front from the direction of the incoming fuel flow, in a rotationally movable manner via ball bearings. During a standstill of the fuel cell system 1, the flap 16 is moved downwardly via its weight and possibly via the force of a spring 17, indicated here by way of example, which preferably is provided as a torsion spring in the area of the bearing. The flap then protrudes from the shock pressure chamber 18 in which it is mounted into the flow of the fuel via the connection to the conducting element 19 for the fuel flow, thus damming the flow of the fuel. With higher developing stagnation pressure, the force on the flap 16 against the weight and the elastic force correspondingly increase, so that the flap 16, indicated by the double arrow, is moved upwardly in the direction of the shock pressure chamber 18 and into same. As a result, the fuel flow is able to pass freely through the conducting element 19, and stagnation pressure which has built up upstream from the flap 16 in the flow direction correspondingly decreases. The counterforce, i.e., the weight and the elastic force on the flap 16 in the present case, thus once again becomes predominant, so that the flap 16 is pushed back into the flow and the process begins anew, resulting in a pulsing fuel flow. At low loads this functions extremely well, and the flap 16 undergoes a pulsing motion which achieves the pulsing fuel flow. At higher loads, for which pulsation of the fuel flow is no longer absolutely necessary and is even somewhat undesirable, the flap 16 is held substantially open due to the flow pressure, and remains primarily in the region of the shock pressure chamber 18. The flap then has only a minimal influence on the fuel flow, so that the pressure pulsations decrease in a self-regulating manner at higher flow velocity and higher volume flow of the fuel flow. The pulsation device 14 is autonomous, and requires no external influence via control or regulation. It is necessary only to coordinate and design the elastic force and the weight of the flap 16 for the particular application in the construction of the pulsation device 14.

The design of the flap 16 may in particular be configured in such a way that during the pulsing motion of the flap 16, there is no stop of the flap against one of the adjacent components or walls of the conducting element 19 or the shock pressure chamber 18. In this way, the motion of the flap 16, and thus the generation of the pulsing gas flow, may be achieved by the pulsation device 14 with virtually no additional noise. Together with the design of the metering valve 8 as a proportional valve, which is already very advantageous with regard to noise levels, this results in a very low-noise device for metering the fuel, which allows precise metering as well as pulsation of the fuel flow, in particular for small and average volume flows.

The illustration in FIG. 4 shows another embodiment of a pulsation device 14, which makes use of the so-called hydrodynamic paradox. An outlet nozzle 20 is connected to the conducting element 19 for the incoming fuel flow. The outlet nozzle is composed of a nozzle opening 21, which in the present case is essentially the end of the conducting element 19, and a part which is referred to as an extension 22. The extension may have the design of a circular disk, for example. The extension 22 could conceivably also have another shape such as a funnel. A deflection element 23 is present subsequent to the outlet opening in the flow direction. The shape of the deflection element corresponds to that of the extension 22, i.e., in the exemplary embodiment illustrated here is designed as a circular disk. In the embodiment of the extension 22 as the above-mentioned funnel which is likewise possible in principle, the deflection element 23 would accordingly then have the design of a cone.

The pulsation device 14 now functions in such a way that the flow downstream from the exit from the outlet opening 21 is correspondingly deflected by the deflection element 23. The deflected flow then passes through the gap 24, discernible in FIG. 4, between the deflection element 23 and the extension 22 of the outlet nozzle 21. Due to the high flow velocity in the gap 24, the pressure in the region of the gap 24 is lower than in the surroundings of the assembly, in particular in the region of the deflection element 23 on its side facing away from the outlet opening 21. The deflection element 23 is thus pressed increasingly in the direction of the outlet opening 21 as the flow velocity increases. As soon as the pressure is high enough that the deflection element 23 contacts the extension 22, the deflection element closes the outlet opening 21, and the gap 24 is eliminated. As a result, the pressure between the extension 22 and the deflection element 23 immediately conforms to the pressure which prevails in the surroundings. The deflection element 23 is therefore no longer pressed in the direction of the extension 22, so that the gap 24 develops again and the flow through the gap 24 begins anew. With increasing flow, the pressure in the gap 24 once again decreases, the gap becomes correspondingly smaller, and the described process is repeated. Here as well, the result is a pulsing fuel flow downstream from the pulsation device 14.

In both described embodiments of the pulsation device 14, it is conceivable and possible to provide a fixing device 25 by means of which the movable element, i.e., the flap 16 or the deflection element 23, may be fixed. For example, the fixing device 25 could be designed as an electromagnet if the movable element 16, 23 is made of a magnetizable material. Thus, for example, the flap 16 could be held in its upper position, or the deflection element 23 could be held in the position which opens up the gap 24 so that maximum flow may pass through. As an alternative to such a fixing device 25, one possible embodiment of a mechanical fixing device 25 is shown in the illustration in FIG. 5. In the embodiment of the movable element as a flap 16, such a fixing device 25 may be situated, for example, on the side of the shock pressure chamber 18 facing away from the rotatable bearing of the flap 16. In the embodiment of the movable element as a deflection element 23, three or more fixing devices 25 uniformly distributed over the periphery of the deflection element 23 would ideally be possible. In the illustration in FIG. 5, the orientation of the figure has been selected so that it essentially corresponds to the illustration in FIG. 3. When used with the deflection element 23 as a movable element, in the embodiment illustrated in FIG. 5 the gap 24 would be understood to be below the movable element 16, 23, which is shown there in its end position. The pulsation of the movable element 16, 23 is indicated by the double arrow. The fixing device 25 has a ratchet 26 which is pressed in the direction of the movable element 16, 23, for example by the force of a spring 27, in order to fix the movable element 16, 23. Since the position of the movable element 16, 23 at the time of activation of the fixing device 25 is typically not known, the design illustrated in FIG. 5 is particularly advantageous. If the movable element 16, 23 is already situated above the ratchet 26, it will remain there. If it is still below the ratchet 26, it is moved upwardly against a sloped surface 28 of the ratchet 26. The ratchet 26 is pushed back against the force of the spring 27, and the movable element 16, 23 is able to move past the ratchet 26. Due to the force of the spring 27, the ratchet is then pushed back into the position illustrated in FIG. 5, and the movable element 23 is held above the ratchet 26. In addition, the ratchet 26 may be actively controlled via an actuator 29, so that, for example, the ratchet may be moved from the engagement area of the movable element 16, 23 against the force of the spring 27 when the pulsation is not to be interrupted. A movement into the position illustrated in FIG. 5 due to the actuator 29 is also possible if needed.

The fixing device 25 may now preferably be used in such a way that above a certain predefined volume flow, which typically corresponds to a predefined load on the fuel cell system 1, it is moved into the position illustrated in FIG. 5. As soon as the movable element 16, 23 has moved past the ratchet 26, the movable element is fixed and cannot fall back into the area of the flow. The pulsation of the flow in the conducting element 19 then ceases, resulting in continuous flow through the conducting element 19. If the volume flow in the conducting element 19 or the load on the fuel cell 3 decreases once again, the movable element 16, 23 may be re-enabled via the actuator 29, and the pulsation device 14 may once again provide a pulsed fuel flow in the conducting element 19.

In addition to or in particular as an alternative to the by-pass 13 described for FIG. 2, the fixing device 25 for preventing the pulsation of the fuel flow may be used with the by-pass valve 15.

The fuel cell system 1 having the device for supplying fuel, which includes the pulsation device 14 in one of the described embodiments, allows very good efficiency with minimal complexity and minimal installation space. This is due to the fact that on account of the improved discharge of water, on the one hand greater fuel cell power for the same fuel flow used is achieved under partial load of the fuel cell system 1, and on the other hand, the pressure losses in the recirculation line 9 are reduced. As a result, the power required for the recirculation conveying device 10 may be reduced. As a whole, therefore, the design has a positive effect on the overall efficiency of the fuel cell system 1.

Such a fuel cell system 1 is particularly suited for use in the previously mentioned vehicle 2. The vehicle 2 may in particular be a passenger vehicle, but may also be a rail vehicle, an unmanned logistics vehicle, a ship, or the like. The fuel cell 3 may provide the electrical power for this vehicle 2. The power may be used on the one hand for the electronics of a vehicle electrical system, but is intended to be provided in particular as drive power for the vehicle 2.

1. The device for supplying fuel to a fuel cell (3) via a metering valve (8), wherein the metering valve (8) is a proportional valve, and a pulsation device (14) is situated downstream from the metering valve (8) in the flow direction, via of which at least one of pressure and volume flow of the metered fuel flow may be varied.

2. The device according to claim 1, wherein the pulsation device (14) has a movable element (19, 23) which by its movement varies the constriction of a cross section for the gas flow through which flow may pass, the movable element (19, 23) automatically moving in a pulsing manner due to a flow-induced variable force and a thereto counterforce.

3. The device according to claim 2, wherein the fuel gas flow has a center, and wherein the movable element is a flap (19) which is fastened in a rotationally movable manner to a front end, in the direction of the fuel gas flow, outside the center of the fuel gas flow.

4. The device according to claim 2, wherein the flap (19) is situated in a chamber (18) which adjoins the flow and which is connected to the cross section through which flow may pass, the flap (19) protruding into the flow at least in its one end position in which it is pressed by the counterforce.

5. The device according to claim 2, wherein as a movable element, the pulsation device (14) has an outlet nozzle (20), and a deflection element (23) whose distance from the outlet nozzle (20) is freely changeable by moving at least between a position which closes the outlet nozzle and a position at a distance from the outlet nozzle (20), the outlet nozzle (20) having an outlet opening (22) and an extension (22) which corresponds to the deflection element (23), so that more or less of a gap (24) through which flow passes is formed between the deflection element (23) and the extension (22) of the outlet nozzle (20) as a function of the automatically changing position of the deflection element (23).

6. The device according to claim 2, wherein a fixing device (25) for fixing the movable element (16, 23) is provided.

7. The device according to claim 6, wherein the fixing device (25) fixes the movable element (16, 23) in a position which largely enables the flow.

8. The device according to claim 1, wherein the pulsation device (14) is variable in its cross section for the fuel flow via active control.

9. The device according to claim 1, wherein a by-pass line (13) having a valve unit (15) is provided around the pulsation device (14).

10. A fuel cell system (1) having at least one fuel cell (3) and a device for supplying fuel to the fuel cell (3) according to claim 1.
